(19) United States
(12) Patent Application Publication
(10) Pub. No.: US 2022/0314327 A1
(43) Pub. Date: Oct. 6, 2022

(54) Method For Producing At Least One Component In A 3D Printing Method, And 3D Printer

(71) Applicant: ExOne GmbH, Gersthofen (DE)

(72) Inventors: Andreas Müller, Augsburg (DE); Roland Ladewig, Windeby (DE)

(21) Appl. No.: 17/616,665

(22) PCT Filed: Jun. 4, 2020
(86) PCT No.: PCT/EP2020/065536

§ 371 Date: Dec. 5, 2021

(30) Foreign Application Priority Data
Jun. 7, 2019 (EP) 19179085.6

(51) Int. Cl. B22F 12/17; B22F 10/14; B22F 12/30; B22C 9/02; B29C 64/165; B29C 64/245; B29C 64/295; B29C 64/393; B33Y 10/00; B33Y 80/00; B33Y 50/02; B33Y 30/00

(52) U.S. Cl. CPC B22F 12/17; B22F 10/14; B22F 12/30; B22C 9/02; B29C 64/165; B29C 64/245; B29C 64/295; B29C 64/393; B33Y 10/00; B33Y 80/00; B33Y 50/02; B33Y 30/00

(57) ABSTRACT

Disclosed is a method of manufacturing at least one component by 3D printing on a construction platform provided with a heating device, the method comprising: applying a layer of loose particulate material to the construction platform, heating the applied layer of loose particulate material by means of the heating device of the construction platform, outputting a liquid treatment agent onto a partial area of the heated layer of loose particulate material, and repeating said steps to build up the at least one component in layers. The heating by means of the heating device of the construction platform is carried out in such a manner that a temperature of the construction platform increases toward a predetermined construction platform maximum temperature during the build-up of the component to set a surface temperature of the respectively last applied layer.

The present invention relates to a method of manufacturing at least one component by 3D printing and to a 3D printer.

Various generative manufacturing processes and 3D printing processes, respectively, (and consequently various types of 3D printers, i.e. machines/equipment for building up a component in layers) are known.

Some generative manufacturing processes have the following steps in common:

(1) First, particulate material (or particulate construction material) is applied over the entire surface of/continuously on a construction field, so as to form a layer of unsolidified particulate material.

(2) The applied layer of unsolidified particulate material is selectively solidified in a predetermined partial area (in accordance with the component to be manufactured), for example by selectively printing a (for example liquid) treatment agent, for example a binding agent, for example a binder.

(3) Steps (1) and (2) are repeated to manufacture a desired component. For this purpose, a construction platform on which the component is built up in layers may, for example, be lowered by respectively one layer thickness before a new layer is applied (alternatively, a/the coater and a/the printing device may, for example, be raised by respectively one layer thickness).

(4) Finally, the manufactured component which is formed by the solidified partial areas and is supported and surrounded by loose, unsolidified particulate material may be unpacked.

A/the construction space in which the component or the components is/are manufactured may, for example, be defined by a so-called construction box (also referred to as job box, for example formed as a so-called interchangeable container). A construction box of this type may have a circumferential wall structure which is open in an upward direction and extends in a vertical direction (for example formed by four vertical side walls), which may, for example, be formed to be rectangular when viewed from above. A height-adjustable construction platform may be received in the construction box. In this respect, the space above the construction platform and between the vertical circumferential wall structure may for example at least contribute to forming the construction space. An upper area of the construction space may, for example, be referred to as a construction field.

Building up one or more three-dimensional components in a/the construction space in layers may, for example, take place by selectively solidifying several adjacent particulate material layers in a respective partial area thereof, for example by binder jetting, i.e. by (selective) “bonding” of the (particulate) construction material with a (for example liquid) treatment agent, for example binding agent, for example binder.

In the above step (1), a coater (also referred to as a recoater) is usually used. Different coaters are known for use in a 3D printer, by means of which a particulate construction material can be applied in the form of a uniform, full-area/continuous layer to the construction field (also referred to as construction surface or construction area).

One type of coater uses a roller (a so-called roller coater), in front of which a quantity of particulate material is first deposited and which is then moved horizontally across the construction field to apply the particulate construction material to the construction field in the form of a uniform layer. The roller can be rotated in the opposite direction in this regard.

Another kind of coater (a so-called container coater, for example a slot coater) uses a container which defines an inner cavity for receiving particulate material, and has an (for example elongate) output region, for example comprising an (for example elongate) output slot for outputting the particulate construction material. The container coater may, for example, be movable across a/the construction field (for example horizontally, for example transverse to its longitudinal direction), wherein the particulate construction material can be output onto the construction field through the (elongate) output region to thereby apply a uniform, full-area/continuous particulate material layer on the construction field and the construction platform, respectively. The coater may be elongate, for example, to span or to cover the length or width of a rectangular construction field.

In the above step (2), a printing device having a print head may for example be used, which applies a (for example liquid) treatment agent in a controlled way onto a partial area of a/the construction material layer applied before (so-called binder jetting). The treatment agent contributes to a (direct and/or later) solidification of the construction material layer in the partial area. For example, the treatment agent may be/contain a binding agent, for example binder, for example a binder component of a multicomponent binder.

It may be regarded as an object of the present invention to provide a method of manufacturing at least one component by 3D printing and a 3D printer, by means of which a component can be manufactured efficiently by 3D printing, in particular by means of binder jetting.

Alternatively or in addition, it may be regarded as an object of the present invention to provide a method of manufacturing at least one component by 3D printing and a 3D printer, by means of which a component can be reliably manufactured by 3D printing, in particular by means of binder jetting.

For this purpose, the present invention provides a method of manufacturing at least one component by 3D printing according to claim 1 and a 3D printer according to claim 13. Further embodiments according to the invention are the subject of the dependent claims.

According to an aspect of the invention, a method of manufacturing at least one component (for example, a casting core and/or a casting mold) by 3D printing on a construction platform provided with a (for example, electric) heating device (and which may be accommodated, for example, in a construction box) may comprise the following steps:

applying a layer of loose particulate material (for example sand particles and/or salt particles, for example those for foundry technology) to the construction platform, for example by means of a coater, which may for example be configured as described above,

heating the (last) applied layer of loose particulate material by means of the heating device of the construction platform,

outputting a liquid treatment agent onto a partial area of the last applied/heated layer of loose particulate material (for example by means of a printing device having a print head, for example by so-called binder jetting),

repeating the above steps to build up (at least partially) the at least one component (in layers),

wherein the heating is performed by means of the heating device of the construction platform in such a way that

a temperature of the construction platform increases during the build-up of the component toward a predetermined construction platform maximum temperature (in particular in the course of and/or as a consequence of repeating the above steps) to set a surface temperature of the respectively last applied layer.

According to this aspect of the invention, heat is thus introduced into the layer composite arranged on the construction platform during the build-up of the component, namely from below, starting from the construction platform or the heating device thereof, wherein a temperature of the construction platform increases during the build-up of the component toward a predetermined construction platform maximum temperature, in order to set a surface temperature of the respectively last applied layer. This allows a large amount of heat to be introduced into the layer composite (already) during the build-up of the component, which in turn contributes to a (pre-)curing of the component or the treatment agent/binder, respectively, namely without damaging the component and/or components of the 3D printer. While it may be known to heat the construction field from above, for example using an infrared emitter, this can essentially only introduce heat into the uppermost layer, which in turn can only contribute to a curing of the entire layer composite and/or the layers thereunder to a limited extent. In addition, it has been found that as the thickness of the layer composite increases, the temperature of the construction platform can be increased to introduce a large amount of heat into the layer composite over time, wherein, due to the increasing thickness of the layer composite of particulate material, the temperature at the surface can still be kept within a set range, which is harmless, for example, to a print head and/or with regard to a binder system used (for example, a range in which evaporation of solvent of the treatment agent is not critical for the print head) and/or which creates a defined reaction environment and/or a defined treatment agent application environment, which in turn can contribute to a reliable manufacturing of the component with good adhesive forces between the layers. Furthermore, by suitable selection of the construction platform maximum temperature, damage to the component in an area directly on/above the construction platform can be avoided. In this respect, it may further be known to introduce a heat fluid through a porous, heatable construction platform into the layer composite, but this is done with a constant heat fluid temperature over the build process, i.e., a temperature of the construction platform does not increase toward a predetermined construction platform maximum temperature, but is constant, and in addition, a possibly undesirable fluidization of the particulate material may occur as a result. Thus, it is possible with the method according to this aspect of the invention to enable curing of binder jetting 3D printed components already during the printing process by means of the heating device of the construction platform, and thus to accelerate curing altogether in order to ultimately manufacture the component efficiently. The increase in the construction platform temperature during the build-up of the component toward a predetermined construction platform maximum temperature, in turn, enables reliable manufacturing of the component without risking damage to the component (in particular by suitable selection of the maximum value) and/or to components of the 3D printer (in particular by suitable selection of the course of the construction platform temperature increase or by suitable selection of the setting of the temperature at the construction platform surface). In this regard, the above steps may overlap in time, for example. In this regard, the above three steps are performed, for example, for each of a plurality of component forming layers (for example, for all of the component forming layers or a predominant number (more than half) of the component forming layers or for a substantial number (e.g., 25% or more, e.g., 30% or more, e.g., 35% or more, e.g., 40% or more, e.g., 45% or more) of the component forming layers). For example, the above three steps may be repeated for a number of at least 250 (for example) consecutive layers. The increase in the temperature of the construction platform during the build-up of the component toward the predetermined construction platform maximum temperature may be, for example, gradual, for example, constant/continuous, for example, stepwise or linear, or according to some other function. For example, the temperature of the construction platform may increase during the build-up of the component starting from a temperature of less than or equal to 70° C. toward the predetermined construction platform maximum temperature (in particular as part of and/or as a consequence of repeating the above steps), i.e. when heating a first layer or a layer applied early in the process, the construction platform temperature is less than or equal to 70° C., for example less than or equal to 65° C., for example less than or equal to 60° C., for example less than or equal to 55° C. For example, a temperature of the construction platform may undergo an increase/temperature difference of greater than or equal to 100° C., for example greater than or equal to 125° C., for example greater than or equal to 150° C., for example greater than or equal to 175° C., during the build-up of the component, i.e., between a time of application of the first component layer and the last component layer. The (gradual) increase in the construction platform temperature to the maximum temperature may extend, for example, over the application of more than 100 layers, for example, more than 150, for example, more than 200.

For example, in the method, the liquid treatment agent may (indirectly or directly) contribute to and/or result in (selective) bonding of the (loose) particulate material (and of the particles of the (loose) particulate material, respectively). For example, the liquid treatment agent may comprise an agent for (selectively) bonding the (loose) particulate material (and the particles of the (loose) particulate material, respectively). For example, the liquid treatment agent may be output to (selectively) bond the (loose) particulate material (and the particles of the (loose) particulate material, respectively) (to each other). For example, the liquid treatment agent may be output to (selectively) bond the (loose) particulate material (and the particles of the (loose) particulate material, respectively).

For example, in the method, the liquid treatment agent may comprise a liquid binding agent (for example, a liquid binder) and/or a liquid component of a multi-component binding agent (for example, a liquid component of a multi-component binder). The liquid binding agent and/or the liquid component of the multi-component binding agent may, for example, (indirectly or directly) contribute to and/or result in (selective) bonding of the (loose) particulate material (and particles of the (loose) particulate material, respectively).

For example, in the method, the liquid treatment agent may comprise an organic binding agent or a component of an organic binding agent or an inorganic binding agent or a component of an inorganic binding agent. For example, the organic binding agent may comprise a phenol-based binding agent (for example, a phenolic/phenol resin) and/or a furan-based binding agent (for example, a furan resin). The inorganic binding agent may comprise, for example, a waterglass-based binding agent (for example, a waterglass).

During (selective) bonding, the (loose) particulate material (and the particles of the (loose) particulate material, respectively) may be bonded, for example, such that the particulate material (and the particles of the particulate material, respectively) retains (or does not change) its shape and/or form. That is, during (selective) bonding of the (loose) particulate material (and the particles of the (loose) particulate material, respectively), for example, no melting (or fusing) and/or sintering and/or (thermal) softening and/or deformation of the particulate material (and the particles of the particulate material, respectively) takes place. During (selective) bonding, for example, the (output) treatment agent (for example, the binding agent, for example, the binder) may be arranged in solid (or solidified) form (for example, in cured form) between the particles of the particulate material to bond (or hold together) the particles. That is, during (selective) bonding, the particulate material (and the particles of the particulate material, respectively) may be (selectively) bonded together, for example, by solid (or solidified) (for example, cured) treatment agent (for example, binding agent, for example binder).

Heating by means of the heating device of the construction platform may be carried out, for example, in such a way that the construction platform is heated until the predetermined construction platform maximum temperature is reached, in particular if the component to be manufactured has a component thickness sufficient/corresponding thereto.

For example, after the predetermined construction platform maximum temperature has been reached, the construction platform temperature may be maintained at the predetermined construction platform maximum temperature. This may result in some decrease in the temperature at the construction field surface for the remaining layers to be applied (compared to a temperature of the construction field surface for the layers prior to reaching the construction platform maximum temperature or during the increase in the construction platform temperature; for particularly thick components, the construction field surface temperature for component layers applied later can drop substantially to ambient temperature due to the layer composite arranged therebetween), but this has proven acceptable in practice with regard to a suitable treatment agent application environment (moreover, if required, additional heating could also be provided from above, for example by means of an infrared heater). This can further promote curing of the component.

For example, the predetermined construction platform maximum temperature may be in a range of 180-320° C., for example 200-300° C., for example 220-280° C., for example 240-260° C., and/or may be selected depending on the treatment agent and/or the particulate material. For example, it may be provided that a user may specify a corresponding construction platform maximum temperature to the 3D printer via a corresponding user interface, for example by entering or selecting the temperature or by entering or selecting a treatment agent or material pairing, etc. The predetermined construction platform maximum temperature may also be preset, for example. The predetermined construction platform maximum temperature may for example be a constant value, and may for example be 250° C.

The surface temperature of the respectively last applied layer can be set (as a result of heating of the layer composite by means of the heating device), for example, to a temperature of less than or equal to 70° C. (for example, of less than or equal to 65° C., for example, of less than or equal to 60° C., for example, of less than or equal to 55° C.), for example, during (carrying out) the entire process and/or during the entire build-up of the component, i.e., for example, until the construction platform temperature reaches the predetermined construction platform maximum temperature and also thereafter (during a holding of the construction platform temperature at the maximum temperature). The surface temperature of the respectively last applied layer can be set (as a result of heating the layer composite by means of the heating device), for example, to a temperature in a range of 30-70° C., for example 35-65° C., for example 40-60° C., for example 45-55° C., (at least) as long as the predetermined construction platform maximum temperature is not reached/until the predetermined construction platform maximum temperature is reached. Subsequently, i.e. after reaching the construction platform maximum temperature, there may be a drop in the surface temperature as described above (despite further heating by means of the heating device at the predetermined construction platform maximum temperature), as a result of the application of fresh layers and due to the increasing thickness of the layer composite, and ultimately also a leaving of said range. For example, the surface temperature of the respectively last applied layer may be set to a substantially constant temperature as long as the predetermined construction platform maximum temperature is not reached. For example, the surface temperature may be a temperature selected as a function of the treatment agent.

For this purpose, according to an embodiment, a suitable course of the construction platform temperature and of its increase, respectively, may for example be determined in advance, for example experimentally, in order to achieve the above setting of the surface temperature in the range. The construction platform temperature may then be controlled according to/to the determined course for manufacturing the component.

According to another embodiment, the setting of the surface temperature of the respectively last applied layer may be performed, for example, by means of a temperature control (by the heating device) using a surface temperature set value specification as long as the predetermined construction platform maximum temperature is not reached. For example, provision may be made for a user to specify a corresponding surface temperature set value to the 3D printer (prior to starting the construction job) via a corresponding user interface, for example by entering or selecting the temperature or by entering or selecting a treatment agent (for which a corresponding set value temperature is stored). The predetermined surface temperature set value may also be preset, for example. Thus, for example, as long as the predetermined construction platform maximum temperature has not been reached, the surface temperature (=construction field temperature) may be controlled to a predetermined set value temperature using the heating device of the construction platform, with the temperature of the construction platform increasing toward the predetermined construction platform maximum temperature during the build-up of the component as a result of/for the purpose of said temperature control. For this purpose, for example, for each applied component layer (or, for example, for every second or third applied component layer), a matching of the surface temperature with the set value may be carried out one or more times, followed by a setting of the heating power corresponding to the matching. Once the construction platform maximum temperature has been reached, the temperature control can then be set, for example, and the construction platform temperature can be maintained at the construction platform maximum temperature. Even if a drop in the surface temperature is subsequently to be expected, due to the constant construction platform temperature and the further deposition of layers, the surface temperature can be further determined in order to be able to intervene accordingly or take appropriate measures if the set value and/or a critical value is exceeded. According to this embodiment, it is possible to make the heat input into the layer composite particularly high in that, until the construction platform maximum temperature is reached, a high heat input set by suitable set value selection is ensured, which, however, avoids damage to, for example, the print head.

For example, in the method, the surface temperature can be detected/monitored by at least a first temperature sensor (this can be done, for example, for each applied component layer or, for example, for every second or third applied component layer, for example respectively one or more times) and/or the construction platform temperature can be detected/monitored by at least a second temperature sensor. The second temperature sensor may, for example, comprise or be formed by a PTC. The second temperature sensor may, for example, be provided on or in the construction platform, for example on the construction platform underside. The first temperature sensor may, for example, comprise or be formed by an infrared sensor. For example, the first temperature sensor may be provided above and facing the construction field.

For example, in the method, a first temperature value sensed by the first temperature sensor may be compared to the set value specification and/or a second temperature value sensed by the second temperature sensor may be compared to the predetermined construction platform maximum temperature. For example, based on the result of the comparison, setting/adjusting the heating power of the heating device may be performed.

For example, in the method, the construction platform may be configured to be fluid-impermeable and/or heating of the applied layers of loose particulate material may be performed in the absence of a (heat) fluid flow and/or heating of the applied layers of loose particulate material may be performed in the absence of a heating device provided above the respectively last applied layer.

For example, in the method, the heating device may be arranged at, for example on, and/or in the construction platform. For example, the heating device may be configured to heat the construction platform over an area, i.e., substantially the entire surface thereof, in particular uniformly.

For example, in the method, the liquid treatment agent may comprise an organic binding agent, for example, a phenol-based binding agent, for example, a phenolic resin, or a furan-based binding agent, for example, a furan resin, or an inorganic binding agent, for example, a waterglass-based binding agent, for example, a waterglass, and/or the particulate material may comprise sand particles and/or salt particles and/or metal particles, and/or the component may be a casting core and/or a casting mold.

For example, in the method, the construction platform may be maintained at the predetermined construction platform maximum temperature for a predetermined period of time after completion of the at least one component, for example prior to unpacking the component, i.e., while the manufactured component formed from the solidified/treated partial areas is surrounded by the loose, unsolidified particulate material.

According to a further aspect of the invention, a 3D printer may comprise

a construction platform provided with a heating device,

a coater for applying a layer of loose particulate material on the construction platform,

a print head for outputting a liquid treatment agent onto a partial area of a last applied layer of loose particulate material, and

a control device configured to perform the method described above. That is, the control device may be configured, for example, to appropriately control the construction platform, including the heating device, the coater, and the print head so that they perform the above-described process.

The 3D printer may further comprise, for example:

a first temperature sensor for sensing a surface temperature of the last applied layer, and/or

a second temperature sensor for sensing a temperature of the construction platform. The first and second temperature sensors may, for example, be connected to the control device.

In the 3D printer, for example, the construction platform may be configured to be fluid-impermeable and/or the heating device may be disposed at, for example on, and/or in the construction platform.

Exemplary, but non-limiting embodiments of the invention are explained in more detail below.

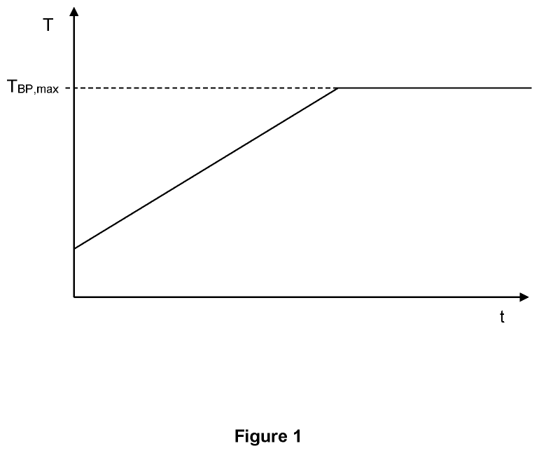

FIG. 1 shows a (schematic) diagram of a temperature curve of the construction platform temperature according to a first embodiment, as it may occur in a method according to the invention.

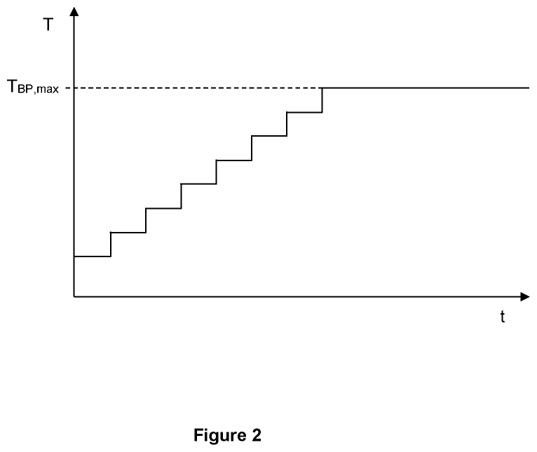

FIG. 2 shows a (schematic) diagram of a temperature curve of the construction platform temperature according to a second embodiment, as it may occur in a method according to the invention.

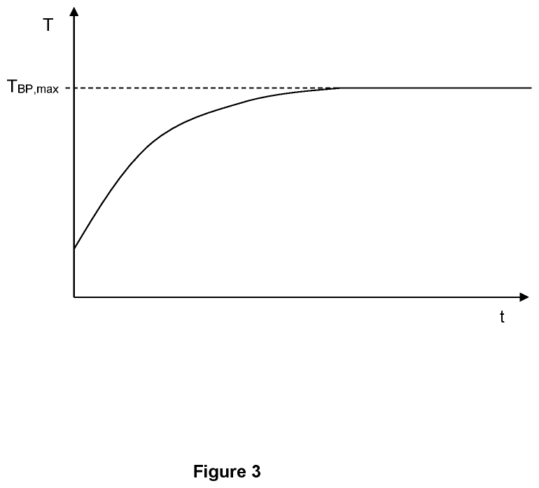

FIG. 3 shows a (schematic) diagram of a temperature curve of the construction platform temperature according to a third embodiment, as it may occur in a method according to the invention.

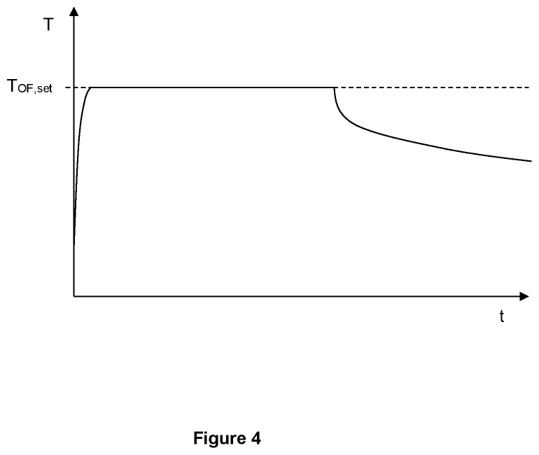

FIG. 4 shows a (schematic) diagram of a temperature curve of the surface temperature of the respectively last applied layer according to a fourth embodiment, as it may occur in a method according to the invention.

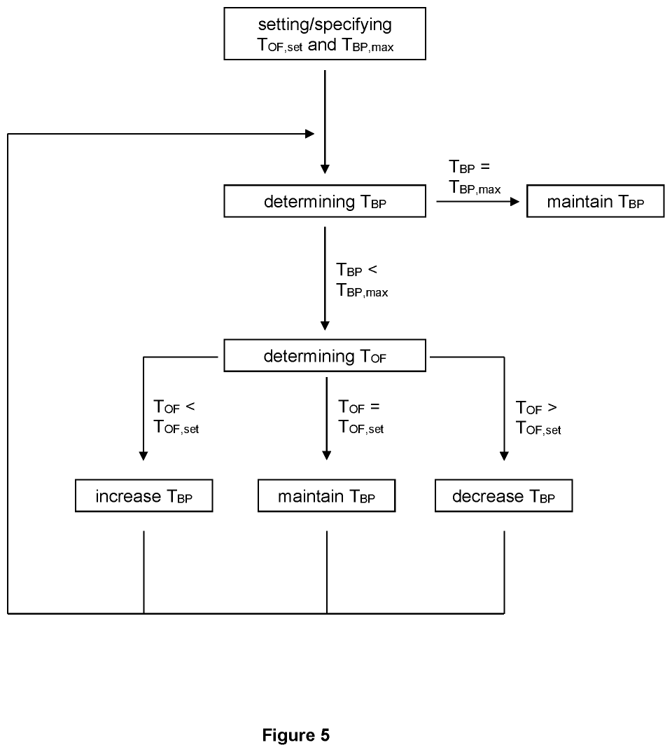

FIG. 5 shows a flow chart of a control sequence according to a fifth embodiment.

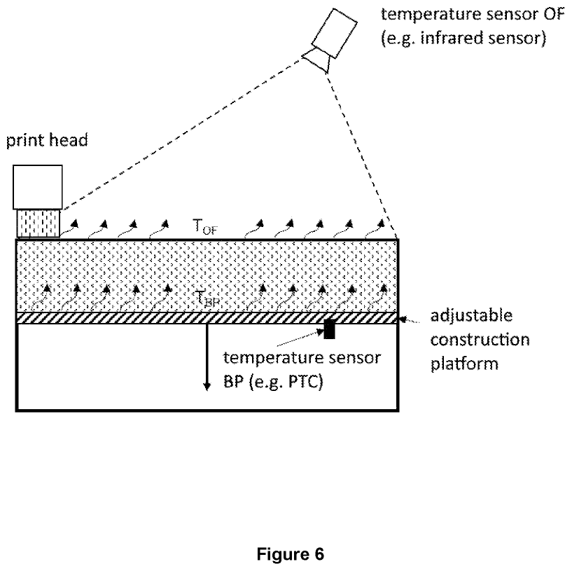

FIG. 6 shows a 3D printer according to a sixth embodiment.

In the following detailed description, reference is made to the enclosed Figures which are incorporated therein and in which specific embodiments are shown by way of illustration, according to which the invention can be performed.

It shall be understood that other embodiments may be used and structural or logical changes may be made without deviating from the scope of protection of this invention. It shall be understood that the features of the embodiments described herein may be combined unless specified otherwise. Thus, the following description should not be understood in a restrictive sense and the scope of protection of this invention shall be defined by the attached claims.

In FIGS. 1 to 3, time t is plotted on the horizontal axis and temperature T of the construction platform is plotted on the vertical axis. In FIG. 4, time t is plotted on the horizontal axis and temperature T of the surface of the respectively last applied layer is plotted on the vertical axis.

A method of manufacturing at least one component by 3D printing on a construction platform provided with a heating device may comprise the following steps: (1) applying a layer of loose particulate material to the construction platform, (2) heating the applied layer of loose particulate material by means of the heating device of the construction platform, (3) outputting a liquid treatment agent onto a partial area of the heated layer of loose particulate material (according to a section of the component to be manufactured), (4) repeating steps (1) to (3) to build up the at least one component. The heating with the heating device of the construction platform may be performed such that a temperature of the construction platform T_{BP} increases toward a predetermined construction platform maximum temperature T_{BP,max} during the build-up of the component, thereby adjusting a surface temperature of the last applied layer T_{OF}, for example, to a specific value or to a specific temperature range (i.e., the surface temperature is thereby maintained in a specific temperature range).

For example, as shown in FIG. 1, the temperature of the construction platform T_{BP} may increase linearly (for example, at a constant temperature change rate).

As shown in FIG. 2, the temperature of the construction platform T_{BP} may increase, for example, in a step-like or step-wise manner. For example, the temperature of the construction platform T_{BP} may first be maintained at a first temperature for a first period of time and then be maintained at a second, increased temperature for a second period of time, and so on.

As shown in FIG. 3, the temperature of the construction platform T_{BP} may increase, for example, in a curved manner. For example, the temperature curve may have a temperature profile/progression in which the temperature change rate decreases as the construction platform temperature T_{BP} approaches the construction platform maximum temperature T_{BP,max}.

It shall be understood that alternative curves to the temperature curves of the construction platform temperature shown in FIGS. 1 to 3 are possible. For example, the construction platform temperature may increase linearly for a first period of time at a first temperature change rate and may then increase linearly for a second period of time at a second temperature change rate. For example, the temperature curve may have a temperature profile/progression where the temperature change rate increases as the construction platform temperature T_{BP} approaches the construction platform maximum temperature T_{BP,max}.

For example, the temperature curve of the construction platform temperature may be determined (for example, experimentally) prior to carrying out the 3D printing process, and may be set (using the heating device) in a way to set a surface temperature of the respectively last applied layer T_{OF} to a predetermined (for example, substantially constant) temperature value or a corresponding range. The predetermined temperature value or range may, for example, be selected depending on the liquid treatment agent. For example, the predetermined temperature value may be selected such that a print head of the 3D printer from which the liquid treatment agent is dispensed is not damaged or impaired (for example, by sticking together of the print module openings due to evaporation of a solvent component).

As shown in FIGS. 1 to 3, the temperature of the construction platform T_{BP} can be heated, for example, until the predetermined construction platform maximum temperature T_{BP,max} is reached.

As shown in FIGS. 1 to 3, the temperature of the construction platform T_{BP} may be maintained at the predetermined construction platform maximum temperature T_{BP,max} for example, after the predetermined construction platform maximum temperature T_{BP,max} is reached.

The predetermined construction platform maximum temperature may be, for example, in a range of 100-320° C., for example 125-250° C., for example 150-200° C. The predetermined construction platform maximum temperature may be selected, for example, as a function of the treatment agent and/or the particulate material.

The surface temperature of the respectively last applied layer T_{OF} may be set, for example, to a temperature in a range of 30-70° C., for example 30-60° C., for example 30-50° C., for example 30-40° C., for example 35° C., at least as long as the predetermined construction platform maximum temperature T_{BP,max} is not reached. In this respect, the surface temperature of the respectively last applied layer T_{OF} may be set, for example, to a (substantially) constant temperature, but it may also move/fluctuate within one of the ranges mentioned or claimed. The surface temperature of the respectively last applied layer T_{OF} may, for example, be set as a function of the treatment agent.

The setting of the surface temperature of the respectively last applied layer T_{OF} via the temperature curve of the heating device may be carried out, for example, by means of a control, by the heating device being operated in accordance with a previously determined temperature curve.

Alternatively, the setting of the surface temperature may be carried out, for example, by means of a temperature control using a set value specification for the surface temperature, for example, until the predetermined construction platform maximum temperature T_{BP,max} is reached. Then the temperature curve of the construction platform temperature results from the control of the surface temperature.

As shown in FIG. 4, the surface temperature of the respectively last applied layer T_{OF} may be set to a set value for the surface temperature T_{OF,set}. This may be performed, for example, by means of the temperature control. Alternatively, for example, the temperature curve of the construction platform temperature may be set/controlled such that the surface temperature of the respectively last applied layer T_{OF} (substantially) corresponds to the set value for the surface temperature T_{OF,set}.

As shown in FIG. 4, the surface temperature of the respectively last applied layer T_{OF} may be increased to the set value for the surface temperature T_{OF,set} and may then be maintained at this set value. When a certain thickness or height of the applied layers is reached and/or the predetermined construction platform maximum temperature T_{BP,max} is reached, a decrease in the surface temperature of the respectively last applied layer T_{OF} may occur (with continued layer application), since the amount of heat emitted by the construction platform may then be too low to maintain the surface temperature of the respectively last applied layer T_{OF} at the set value.

The surface temperature of the respectively last applied layer T_{OF} may, for example, be sensed by at least a first temperature sensor. The temperature of the construction platform T_{BP} may be sensed, for example, by at least a second temperature sensor. See for example FIG. 6.

The first temperature sensor may be, for example, an infrared sensor. The first temperature sensor may, for example, substantially sense the surface temperature of the entire construction field or an average value or maximum value thereof. For example, the first temperature sensor may sense the surface temperature of a particular portion of the construction field, the portion comprising, for example, an area of 20% or less (for example, 10% or less, for example, 5% or less) of the total area of the construction field. For example, a plurality of first temperature sensors may also be provided, each sensing a temperature of a predetermined partial area of the construction field surface, wherein, for example, an average value or maximum value of the sensed temperature values may be used as the surface temperature.

The second temperature sensor may, for example, comprise at least a PTC resistor. For example, a plurality of second temperature sensors may be provided, each sensing a temperature of a predetermined position of the construction platform, wherein, for example, an average value or maximum value of the sensed temperature values may be used as the construction platform temperature.

A first temperature value T_{OF} sensed by the first temperature sensor may, for example, be compared to the set value specification T_{OF,set} (in the case of control). A second temperature value T_{BP} sensed by the second temperature sensor may be compared, for example, with the predetermined construction platform maximum temperature T_{BP,max}.

As shown in FIG. 5, in the context of a control, for example, first the set value for the surface temperature T_{OF,set} and the construction platform maximum temperature T_{BP,max} may be set or predetermined, for example depending on the binding agent system and/or particulate material used. The temperature of the construction platform T_{BP} may then be determined in the method, for example, using the second temperature sensor. The determined construction platform temperature T_{BP} may then be compared to the construction platform maximum temperature T_{BP,max}. If the determined construction platform temperature T_{BP} is equal to (or greater than) the construction platform maximum temperature T_{BP,max}, the construction platform temperature T_{BP} may be maintained at the construction platform maximum temperature T_{BP,max} during the further course of the method, for example. If the determined construction platform temperature T_{BP} is greater than the construction platform maximum temperature T_{BP,max}, the construction platform temperature T_{BP} may be reduced to the construction platform maximum temperature T_{BP,max}, for example, and then maintained at the construction platform maximum temperature T_{BP,max}. If the determined construction platform temperature T_{BP} is less than the construction platform maximum temperature T_{BP,max}, the surface temperature of the respectively last applied layer T_{OF} may be determined, for example, with the first temperature sensor. The determined surface temperature T_{OF} may then be compared to the set value for the surface temperature T_{OF,set}. If the determined surface temperature T_{OF} is less than the set value for the surface temperature T_{OF,set}, the construction platform temperature T_{BP} may be increased, for example. If the determined surface temperature T_{OF} is equal to the set value for the surface temperature T_{OF,set}, the construction platform temperature T_{BP} may be maintained, for example. If the determined surface temperature T_{OF} is greater than the set value for the surface temperature T_{OF,set}, for example, the construction platform temperature T_{BP} may be decreased.

For example, the construction platform may be configured to be fluid-impermeable. Heating of the applied layers of loose particulate material may be performed, for example, in the absence of a fluid flow. Heating of the applied layers of loose particulate material may be performed, for example, in the absence of a heating device provided above the respectively last applied layer.

The heating device (of the construction platform) may be, for example, an electric heating device and may be disposed on and/or in the construction platform.

The liquid treatment agent may be, for example, an organic binding agent, for example, a phenol-based binding agent (for example, a phenolic resin) or a furan-based binding agent (for example, a furan resin). The liquid treatment agent may be, for example, an inorganic binding agent, for example, a waterglass-based binding agent (for example, a waterglass).

The construction platform temperature may be maintained at the predetermined construction platform maximum temperature, for example, for a predetermined period of time after completion of the at least one component before the component is unpacked. After unpacking, the component may be further cured as needed.

For example, a 3D printer may comprise a construction platform (for example, adjustable in height) provided with a heating device, a coater for applying a layer of loose particulate material to the construction platform, a print head for outputting a liquid treatment agent onto a partial area of a last applied layer of loose particulate material, and a control device configured to perform the above-described method.

For example, as shown in FIG. 6, the 3D printer may comprise at least a first temperature sensor for sensing a surface temperature of the last applied layer of loose particulate material T_{OF} and/or at least a second temperature sensor for sensing a temperature of the construction platform T_{BP}. The first and/or second temperature sensor may, for example, be configured as described above.

The construction platform may, for example, be configured to be fluid-impermeable. The heating device may, for example, be arranged on and/or in the construction platform.

1. Method of manufacturing at least one component by 3D printing on a construction platform provided with a heating device, comprising the steps of:
applying a layer of loose particulate material to the construction platform,
heating the applied layer of loose particulate material by means of the heating device of the construction platform,
outputting a liquid treatment agent onto a partial area of the heated layer of loose particulate material,
repeating the above steps to build up the at least one component,
wherein the heating is carried out by means of the heating device of the construction platform in such a way that
a temperature of the construction platform increases toward a predetermined construction platform maximum temperature during the build-up of the component to set a surface temperature of the respectively last applied layer.

2. Method according to claim 1, wherein the heating is carried out by means of the heating device of the construction platform in such a way that
the construction platform is heated during the build-up of the component until the predetermined construction platform maximum temperature is reached.

3. Method according to claim 2, wherein the heating is carried out by means of the heating device of the construction platform in such a way that
the temperature of the construction platform is maintained at the predetermined construction platform maximum temperature during the build-up of the component after the predetermined construction platform maximum temperature is reached.

4. Method according to claim 1, wherein
the predetermined construction platform maximum temperature is in a range of 180-320° C., for example 200-300° C., for example 220-280° C., for example 240-260° C., and/or is selected depending on the treatment agent and/or the particulate material.

5. Method according to claim 1, wherein
the surface temperature of the respectively last applied layer is set to a temperature in a range of 30-70° C., for example 35-65° C., for example 40-60° C., for example 45-55° C., as long as the predetermined construction platform maximum temperature is not reached, for example a constant temperature and/or a temperature selected depending on the treatment agent.

6. Method according to claim 1, wherein
the setting of the surface temperature of the respectively last applied layer is carried out by means of a temperature control using a set value specification for the surface temperature as long as the predetermined construction platform maximum temperature has not been reached.

7. Method according to claim 1, wherein
the surface temperature is sensed by at least a first temperature sensor and/or
the temperature of the construction platform is sensed by at least a second temperature sensor.

8. Method according to claim 7, wherein
a first temperature value sensed by the first temperature sensor is compared to the set value specification wherein the setting of the surface temperature of the respectively last applied layer is carried out by means of a temperature control using a set value specification for the surface temperature as long as the predetermined construction platform maximum temperature has not been reached, and/or
a second temperature value sensed by the second temperature sensor is compared to the predetermined construction platform maximum temperature.

9. Method according to claim 1, wherein
the construction platform is configured to be fluid-impermeable and/or
the heating of the applied layers of loose particulate material is carried out in the absence of a fluid flow and/or
the heating of the applied layers of loose particulate material is carried out in the absence of a heating device provided above the respectively last applied layer.

10. Method according to claim 1, wherein
the heating device is arranged at, for example on, and/or in the construction platform.

11. Method according to claim 1, wherein
the liquid treatment agent comprises an organic binding agent, for example a phenol-based binding agent, for example a phenolic resin, or a furan-based binding agent, for example a furan resin, or an inorganic binding agent, for example a waterglass-based binding agent, for example a waterglass, and/or
the particulate material comprises sand particles and/or salt particles and/or metal particles, and/or
the component is a casting core and/or a casting mold.

12. Method according to claim 1, wherein
the construction platform is maintained at the predetermined construction platform maximum temperature for a predetermined period of time after completion of the at least one component.

13. (canceled)

14. (canceled)

15. (canceled)
